(19) United States
(12) Patent Application Publication
(10) Pub. No.: US 2015/0379772 A1
(43) Pub. Date: Dec. 31, 2015

(54) TRACKING ACCELERATOR FOR VIRTUAL AND AUGMENTED REALITY DISPLAYS

(71) Applicant: SAMSUNG DISPLAY CO., LTD., Yongin-City (KR)

(72) Inventor: David M. Hoffman, Fremont, CA (US)

(21) Appl. No.: 14/704,777

(22) Filed: May 5, 2015

Related U.S. Application Data
(60) Provisional application No. 62/019,342, filed on Jun. 30, 2014.

(51) Int. Cl. G06T 19/00; G06K 9/00; G02B 27/01; G06F 3/01

(52) U.S. Cl. CPC G06T 19/006; G06F 3/012; G06K 9/00671; G02B 27/0172; G02B 27/0176; G02B 2027/0178; G02B 2027/014; G02B 2027/0141; G02B 2027/0187

(57) ABSTRACT

A display system includes: a sensor to detect head movements and to generate sensor data corresponding to the head movements; and a display device to display a first portion of an image according to the sensor data, wherein the first portion is smaller than an entirety of the image.

### CROSS-REFERENCE TO RELATED APPLICATION

This utility patent application claims priority to and the benefit of U.S. Provisional Patent Application Ser. No. 62/019,342, filed Jun. 30, 2014, entitled “TRACKING ACCELERATOR FOR VIRTUAL AND AUGMENTED REALITY DISPLAYS,” the entire content of which is incorporated herein by reference.

### BACKGROUND

Virtual reality and augmented reality systems, such as, for example, Oculus Rift™, Google Glass®, Samsung Gear VR™, Microsoft HaloLens™, Magic Leap™, etc., may utilize head-mounted display (“HMD”) devices that may be worn on the head (such as glasses or goggles) or as part of a helmet to display images. These systems may update the images shown on the HMD devices in response to head movements of the user that are detected by sensors, such as gyroscopes, accelerometers, magnetometers, cameras, etc. In displaying the updated images, various sources of information (e.g., data) may arrive at different times and at different speeds, as well as volatility in rendering the image by the graphics card, and waiting for the slowest piece of information to arrive before updating the image may lead to latency, dropped frames, tracking errors, etc.

For example, a rendering pipeline for some systems may create latency and delay in updating the images, and a rendering time for an image frame may be volatile depending on activities, inputs, events, and rendering complexity. The delay in updating the images in response to the head movements may lead to motion artifacts, such as juddering, latency in overlaying images, color breakup, and/or general sluggishness, which may cause a bad user experience that may lead to headaches and nausea. In many cases, content authors may make tradeoffs in image quality to match the rendering complexity with the display frame rate.

The above information disclosed in this Background section is only for enhancement of understanding of the background of the invention, and therefore, it may contain information that does not form prior art.

### SUMMARY

One or more embodiments of the present invention relate to a virtual or augmented reality display system including a display device having accelerated head tracking, and a method for the accelerated head tracking.

According to an embodiment of the present invention, a display system includes: a sensor configured to detect head movements and to generate sensor data corresponding to the head movements; and a display device configured to display a first portion of an image according to the sensor data, the first portion being smaller than an entirety of the image.

The image may include an oversized image.

The display device may be further configured to crop the oversized image to generate the first cropped portion of the oversized image corresponding to the sensor data during a display frame, and to crop the oversized image to display a second cropped portion of the oversized image corresponding to updated sensor data during a next display frame.

The display device may be further configured to resample the oversized image to generate the first portion of the oversized image corresponding to the sensor data during a display frame.

The image may include an overlay image.

The display device may be further configured to crop the overlay image to generate the first portion of the overlay image corresponding to the sensor data during a display frame, and to crop the overlay image to display a second portion of the overlay image corresponding to updated sensor data during a next display frame.

The display device may be further configured to combine the cropped overlay image with a fixed secondary image.

The display device may be further configured to display color sequentially, and to display corresponding portions of different color subframes when the sensor data indicates different portions of color subframes are to be displayed.

According to another embodiment of the present invention, a display device includes: a buffer configured to store an image; and a controller configured to generate image data to be displayed corresponding to a first portion of the image according to sensor data corresponding to head movements, the first portion being smaller than an entirety of the image.

The image may include an oversized image.

The controller may be further configured to crop the oversized image to generate the image data corresponding to the first portion of the oversized image corresponding to the sensor data during a display frame, and to crop the oversized image to generate the image data corresponding to a second portion of the oversized image corresponding to updated sensor data during a next display frame.

The display device may be further configured to resample the oversized image to generate the first portion of the oversized image corresponding to the sensor data during a display frame.

The image may include an overlay image.

The controller may be further configured to crop the overlay image to generate the image data corresponding to the first portion of the overlay image corresponding to the sensor data during a display frame, and to crop the overlay image to generate the image data corresponding to a second portion of the overlay image corresponding to updated sensor data during a next display frame.

The buffer may include a secondary buffer configured to store a fixed secondary image, and the controller may be further configured to combine the cropped overlay image with the fixed secondary image.

The display device may be configured to display color sequentially, and the controller may be further configured to generate the image data with corresponding portions of different color subframes when the sensor data indicates different portions of color subframes are to be displayed.

According to another embodiment of the present invention, an accelerated head tracking method includes: receiving, by a display device, sensor data corresponding to head movements; and displaying, by the display device, a portion of an image according to the sensor data.

The method may further include: comparing, by the display device, position metadata corresponding to the image with the sensor data to determine a position difference, wherein the portion of the image corresponds to the position difference.

The image may include an oversized image.

The method may further include: resampling, by the display device, the oversized image to generate the portion of the oversized image corresponding to the sensor data during a display frame.

The oversized image may correspond to an oversized overlay image.

The image may correspond to an image of a previous frame that may be stored in a buffer, and the method may further include: resampling, by the display device, the image stored in the buffer; and comparing, by the display device, position metadata corresponding to the image with the sensor data to determine a position difference, wherein the portion of the image corresponds to the position difference.

The method may further include: receiving, by the display device, a fixed secondary image; and combining, by the display device, the portion of the image with the fixed secondary image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects and features of the present invention will become apparent to those skilled in the art from the following detailed description of the example embodiments with reference to the accompanying drawings.

FIG. 1 illustrates a virtual or augmented reality display system according to some embodiments of the present invention.

FIG. 2 illustrates a timing graph from detection of head movements through display of display frames.

FIG. 3 is a block diagram illustrating a virtual or augmented reality display system according to some embodiments of the present invention.

FIG. 4 is a schematic diagram of a display device of the system shown in FIG. 3.

FIGS. 5A and 5B illustrate an example of shifting an oversized image according to detected head movements, according to some embodiments of the present invention.

FIGS. 6A through 6C illustrate examples of aligning an overlay image over an object viewed through a transparent display device of a virtual or augmented reality display system according to tracked head movements.

FIGS. 7A through 7E illustrate examples of color breakup in a color sequential display, and FIGS. 7F through 7I illustrate examples of compensating for color subframes according to detected head movements.

FIG. 8A illustrates an accelerated head tracking method according to some embodiments of the present invention.

FIG. 8B illustrates an accelerated head tracking method according to some embodiments of the present invention.

### DETAILED DESCRIPTION

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and components and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or the like. Further, the various components of these devices may be a process or thread, running on one or more processors, in one or more computing devices, executing computer program instructions and interacting with other system components for performing the various functionalities described herein. The computer program instructions may be stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

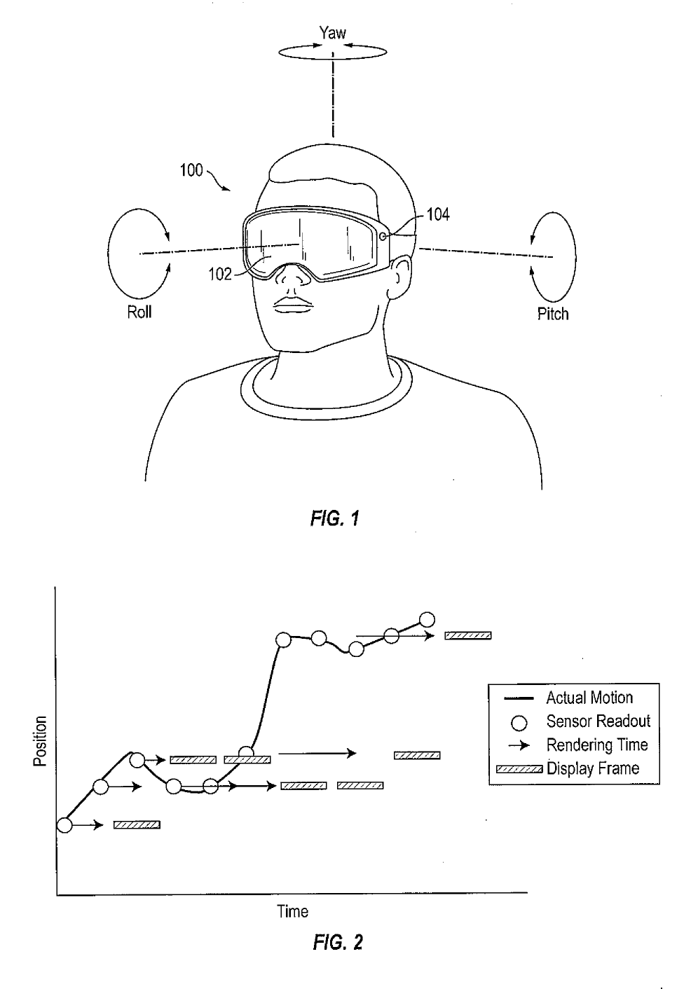

FIG. 1 illustrates a virtual or augmented reality display system according to some embodiments of the present invention.

Referring to FIG. 1, the virtual or augmented reality display system (“system”) 100 includes a display device 102 and at least one sensor (e.g., gyroscopes, accelerometers, magnetometers, optical trackers, cameras, etc.) coupled to the display device 102 and configured to measure the relative movement of the display device 102. In some embodiments, the display device 102 may include a wearable display device, such as for example, the HMD, and may be configured to remain in front of the user no matter what direction the user is looking at. In some embodiments, the display device 102 may include a transparent display device, and the user may view an object through the transparent display device. In some embodiments, the display device 102 may be coupled to a camera 104, and the user may view the object on the display device 102 that is captured by the camera 104. The display device 102 may include any suitable display device, for example, liquid crystal displays (e.g., LCDs), organic light emitting displays (e.g., OLEDs), etc.

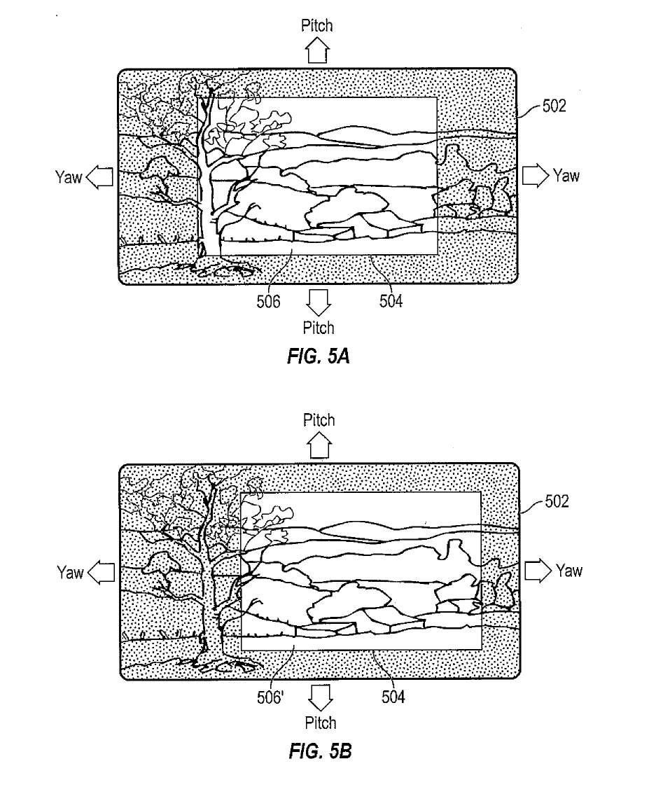

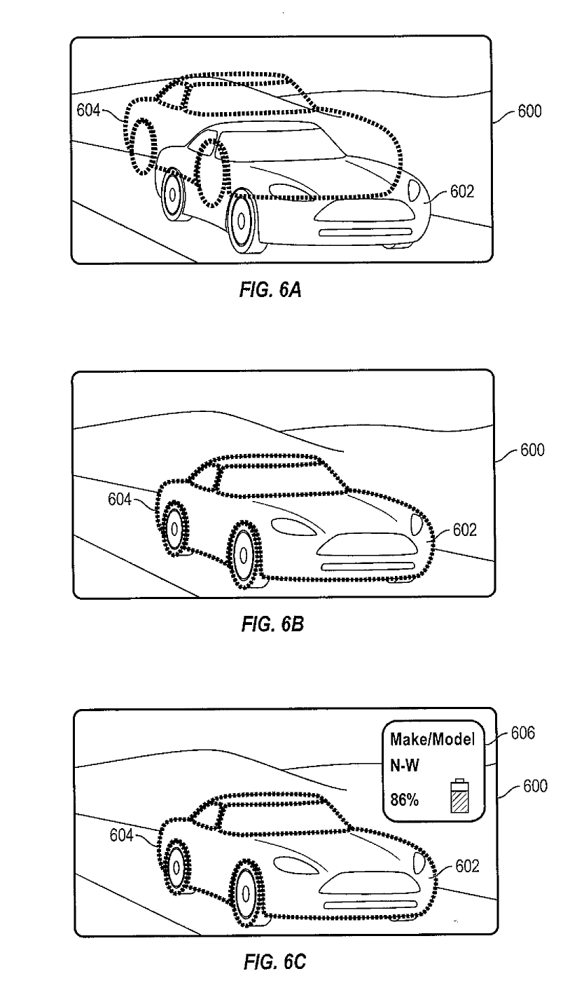

The sensor (e.g., gyroscopes, accelerometers, magnetometers, optical trackers, cameras, etc.) may detect (e.g., track) the user's head movements, and the system 100 may translate the head movements into the images displayed on the display device 102. The virtual or augmented reality display system according to some embodiments of the present invention will be described later in more detail with reference to FIGS. 3 and 4.

As shown in FIG. 1, typical ranges of motion associated with the user's head movements may include pitch (e.g., up and down), yaw (e.g., left and right), and roll (e.g., headroll). Among these, the pitch and yaw motions may be quite fast, and may lead to vertical and horizontal image translation but little changes in perspective. On the other hand, the roll movements, in addition to translation, tend to be relatively slow, as users do not generally make high frequency roll movements.

When the head movements are detected by the sensor, the image may be rendered with scene content of the image being adjusted and updated according to, for example, a viewing position corresponding to the detected head movements. According to some virtual and augmented reality systems, head tracking may be serial and single threaded. Thus, even when only small positional adjustments are made, the entire image is often re-rendered, and the rendering rate is often largely determined or influenced by the rendering complexity. Accordingly, the update of the head tracking position may be based on an old position estimate, resulting in the display of a rendered image that is already obsolete relative to the current head position.

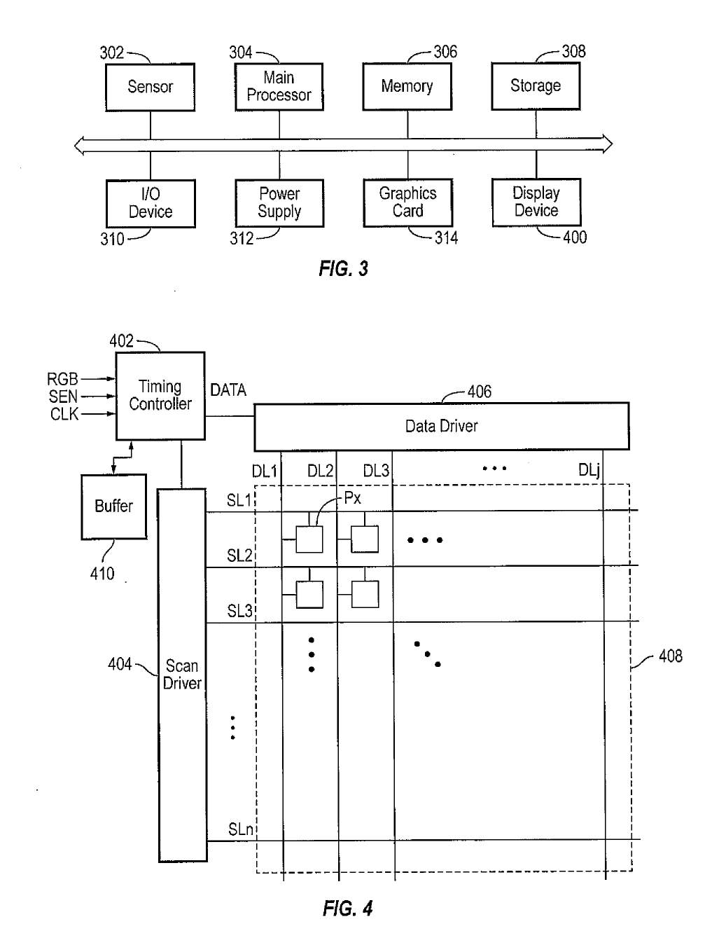

As shown in FIG. 2, a rendering time for a given frame may impose latency in displaying the updated images for some virtual or augmented reality display systems.

FIG. 2 illustrates a timing graph from detection of head movements through display of display frames. In FIG. 2, the X-axis represents time and the Y-axis represents position (e.g., angular position) of the head movements. A thin continuous line represents head motion (e.g., angular motion), circles represent time of sensor readings (e.g., gyroscope readouts), lines ending with an arrow represent rendering time of the images, and thick line segments represent timing of the display frames.

As shown in FIG. 2, the sensor may be readout at a high rate (e.g., a high sampling frequency), and may detect the head movements with little latency. Once the readout is received, rendering generally begins. Depending on the complexity of the image, rendering may be a slow process that may cause latency. For example, as shown in the graph of FIG. 2, the time for rendering the updated image may vary, and thus, may cause latency from the time of the sensor readout to the time the updated image is displayed during a corresponding display frame.

On the other hand, the display device may have its own clock, and may operate relatively independently from the other components of the system. In other words, the display device may include a fixed or substantially fixed frame rate, independent of whether or not the updated image is rendered. Thus, in cases where the rendering takes a long time to complete, the frame rate may trail head tracking, and a same image from a previous display frame may be displayed during a current display frame (e.g., to display double frames), since the updated image has not been received in time for the corresponding display frame. For example, if a display has a refresh rate of 60 Hz and the rendering frame rate is 30 frames per second, then the display will update 60 times in a second while only receiving 30 frames. The result is a frame being displayed twice. As a result, the image to be displayed during the corresponding display frame may not correspond to the latest sensor readouts.

As will be described in further detail below, according to some embodiments of the present invention, the display device may shift a recent image (e.g., a most recent image) according to the sensor reading (e.g., a most recent sensor reading) to be displayed during the corresponding display frame. In other words, the display device may display a portion of the recent image (e.g., a portion of the recent image that is smaller than an entirety of the recent image) according to the sensor readings.

FIG. 3 is a block diagram illustrating a virtual or augmented reality display system according to some embodiments of the present invention, and FIG. 4 is a schematic diagram of a display device of the system shown in FIG. 3.

Referring to FIGS. 3 and 4, the virtual or augmented reality display system 300 includes a sensor 302, a main processor 304, memory 306, a storage device 308, input/output device 310, a power supply 312, a graphics card 314, and a display device 400.

The sensor 302 may include at least one of a gyroscope, an accelerometer, a magnetometer, etc., to detect and track a user's head movements (e.g., yaw, pitch, roll).

The main processor 304 may perform various computing functions. The main processor 304 may be a microprocessor, a central processing unit (CPU), field-programmable gate array (FPGA), application-specific integrated circuit (ASIC), etc. The main processor 304 may be directly coupled to other components of the virtual or augmented reality display system 300, or may be coupled to the other components via an address bus, a control bus, a data bus, etc. Further, the main processor 304 may be coupled to an extended bus, such as a peripheral component interconnection (PCI) bus.

The memory device 306 may store data for operations of the virtual or augmented reality display system 300. The memory device 306 may include at least one non-volatile memory device and at least one volatile memory device. For example, the non-volatile memory device may correspond to an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. In addition, the volatile memory device may correspond to a dynamic random access memory (DRAM) device, a static random access memory (SRAM) device, a mobile dynamic random access memory (mobile DRAM) device, etc.

The storage device 308 may include a solid state drive device, a hard disk drive device, a CD-ROM device, etc. The I/O device 310 may include one or more input devices, such as a keyboard, a trackpad, a keypad, a mouse, a touch screen, a camera, a gamepad, a motion tracking wand, etc., and one or more output devices, such as a printer, a speaker, a haptic actuator, etc. In some example embodiments, the display device 400 may be included as an output device in the I/O device 310. The power supply 312 may provide power for operations of the virtual or augmented reality display system 300.

The graphics card 314 may render images according to the detected head movements, and may transmit image signals RGB corresponding to the rendered images to the display device 400. The graphics card may include a front buffer for storing an image to be displayed during a current frame, and a back buffer for rendering a next image to be displayed during a subsequent display frame (e.g., a next display frame). The front buffer and the back buffer may be swapped or flipped, such that the image rendered in the back buffer may be displayed during the subsequent display frame. In some cases, when the display device is ready to receive the next image for a corresponding display frame, but the rendering of the next image has not been completed, a same image from a previous display frame stored in the buffer (e.g., the front buffer) may be displayed again during the corresponding display frame.

The display device 400 may be directly coupled to the other components of the virtual or augmented reality display system 300, or may communicate with the other components via the buses or other communication links.

As shown in FIG. 4, the display device 400 may include a timing controller 402, a scan driver 404, a data driver 406, and a plurality of pixels Px in a display area 408. Each of the plurality of pixels Px is coupled to respective ones of scan lines SL1 to SLn, where n is a positive integer, and data lines DL1 to DLj, where j is a positive integer, at crossing regions of the scan lines SL1 to SLn and the data lines DL1 to DLj. Each of the pixels Px may receive data signals from the data driver 406 through the respective one of the data lines DL1 to DLj, when scan signals are received from the scan driver 404 through the respective one of the scan lines SL1 to SLn. The pixels Px may display an image according to the data signals received from the data driver 406.

When the display device 400 is a HMD, the display device 400 according to some example embodiments may display a left image and a right image to respectively correspond to a left eye and a right eye of the user. The display device 400 may also include a lens assembly for focusing the left and right images. In some embodiments, the left image and the right image may be a same image. In some embodiments, the left image and the right image may be different images to display a 3-dimentional or stereoscopic image.

According to some example embodiments of the present invention, the display device 400 may be closely integrated with the sensor to shift an image according to the sensor readings, so that a different portion of the image is displayed. For example, the image may be relatively large or oversized such that the display device 400 only displays a portion of the image. As the sensors indicate movement, the display device may then display a different portion of the image without needing a newly rendered image to be provided. By updating the image according to the sensor readings at a time closer to a time for displaying the image during a corresponding display frame, the updated image corresponds more closely to the detected head movements, and latency between head tracking and displaying the updated image may be minimized or reduced.

For example, the display device 400 may receive the sensor readings, and may shift an image (e.g., a recent or most recent image), which may correspond to a new image received from the system (e.g., a new image rendered from the graphics card) or an image of a previous display frame (e.g., an adjacent previous display frame stored in a buffer), according to the sensor readings (e.g., a recent or most recent sensor reading) to display an updated image. In other words, the display device 400 may display a different portion of the image (e.g., a pre-rendered image) according to the updated sensor readings, so that the displayed portion of the image corresponds more closely to the updated sensor readings.

In some embodiments, the display device 400 may further include at least one buffer 410 to store and edit (e.g., shift and/or crop) the recent image of a previous display frame to be displayed during a corresponding display frame (e.g., a current display frame). In some embodiments, the buffer 410 may be populated with data corresponding to a newly rendered image to be displayed during the corresponding display frame. In some embodiments, the buffer 410 may include a secondary buffer to store a frame-fixed secondary image that may be combined (e.g., blended or composited) with the recent image of the previous display frame or the newly rendered image. In some embodiments, the buffer 410 may store image position metadata corresponding to the stored image.

The timing controller 402 may use the image signal RGB from an external source (e.g., external to the display device, such as the graphics card) or may retrieve the data stored in the buffer 410 to generate image data DATA, and may receive synchronization signals and clock signals to control the display device 400. In some embodiments, the timing controller 402 may further receive sensor data SEN corresponding to the head movements detected by the sensor 302.

The timing controller 402 may supply the image data DATA to the data driver 406. The image data DATA may be generated according to the image signal RGB or the data stored in the buffer 410. In some embodiments, the timing controller 402 may generate the image data DATA by shifting (e.g., cropping) the corresponding image according to the sensor data SEN corresponding to the head movements to display a different portion of the corresponding image according to the sensor data SEN. In some embodiments, the timing controller 402 may generate the image data DATA by shifting (e.g., cropping) the image corresponding to a previous display frame (e.g., a previous adjacent display frame), which may be stored in the buffer 410 of the display device 400, according to the sensor data SEN corresponding to the head movements to display a different portion of the image according to the sensor data SEN. However, the present invention is not limited thereto, for example, in some embodiments, a separate accelerator (e.g., a graphics accelerator) and/or controller may receive the sensor data SEN, and may shift the corresponding image according to the sensor data SEN corresponding to the head movements to display a different portion of the image according to the sensor data SEN. In some embodiments, the image may be resampled according to the sensor data SEN corresponding to the head movements to display a different portion of the image according to the sensor data SEN. For example, the image may be resampled when the sensor data SEN indicates a head roll, or instances where geometric warping for an optical aberration is performed.

In some embodiments, when correcting for head roll, there is no rectilinear selection of pixels that produces the correct image. In order to produce an image with the correct roll correction, a new set of pixel locations may be generated. These new pixel locations may not fall directly on the original pixel locations, and in these instances a pixel interpolation technique may be used. The interpolation may make use of common image resampling techniques, including: bilinear, bicubic, nearest neighbor, lanczos kernel, and/or box filter.

In some embodiments, geometric warping may be desirable to correct for lens curvature or chromatic shift. In the case of lens distortion, the original rectilinear pixel locations may need to be adjusted due to the geometric warping of optical elements between the eye and display. In these situations, a warping operation may be desirable in which the rectilinear pixel structure is distorted to the inverse of the optical distortion. The inverse warp may shift pixel locations, and thus, may locally change the pixel pitch. So that all pixels (or a desired portions of pixels) are filled appropriately, the image content may be resampled.

In some embodiments, the lens distorts and/or magnifies the different colors of the display differently. In such cases, the processor may need to apply a slightly different geometric correction and/or magnification for each of the color channels.

In some embodiments, the timing controller 402 may further generate the image data DATA that is a composite of information from the buffer 410, RGB image input, the secondary buffer with the frame-fixed secondary image, or raw sensor data SEN. In some embodiments, the timing controller 402 may be further configured to apply a geometric correction to the RGB and/or buffer and/or overlay data, such that distortions that occur in the optical system of a near-eye display are corrected (e.g., correction for barrel distortion, pincushion distortion, keystone distortion, chromatic aberration, etc.).

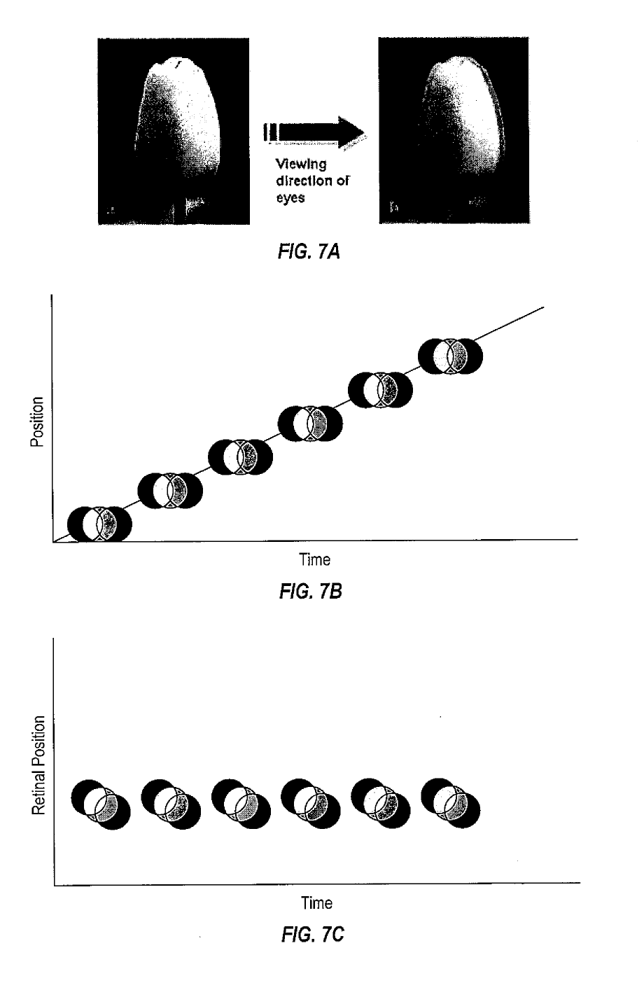

As shown in FIGS. 5A and 5B, according to some embodiments of the present invention, an oversized image may be shifted (e.g., cropped) according to the detected head movements. The shifted image may then be displayed during a corresponding display frame. According to some embodiments of the present invention, the buffer 410 of the display device 400 may store the oversized image for dynamic cropping.

As used herein, the oversized image 502 refers to an image that is larger than a screen size 504 of the display device, where the term the “screen size” refers to a size of an image displayed on the screen. According to some embodiments of the present invention, the size of the oversized image 502 may be determined according to an angular field of view of the image, the expected maximum head rotation speed, and/or the frequencies supported by the system. For example, if the expected maximum head yaw is 30 degrees/sec, and the rendering can support 30 frames/sec, then the system may support up to 1 degree of yaw change, and the oversized image may include at least a 2 degree oversized buffer (e.g., 1 degree on the right edge and 1 degree on the left edge) to support the typical head yaw. There may also be a similar oversized dimension in the vertical direction to compensate for pitch change.

FIGS. 5A and 5B illustrate an example of shifting (e.g., cropping) the oversized image 502, so that a different portion of the oversized image 502 is displayed according to the detected head movements. However, the present invention is not limited thereto, and in some embodiments, a normal sized image (e.g., an image corresponding to the screen size 504 of the display device) may be shifted according to the detected head movements, so that a different portion of the normal sized image may be displayed according to the detected head movements. In this case, the edges of the normal sized image (e.g., where there is no data) may be clipped after shifting (e.g., cropping) the normal sized image, and the shifted normal sized image may appear smaller.

According to some embodiments, the display device may maintain or substantially maintain 1:1 pixel mapping when the image is shifted (e.g. cropped), so as to reduce the risk of resampling artifacts. Selecting the subset of pixels of the shifted image may include an adjustment of the start and end points of the pixel mapping.

Referring to FIG. 5A, for an nth display frame (where n is an integer), the oversized image 502 is shifted according to the sensor data SEN corresponding to a recent or most recent sensor reading, and cropped according to the screen size 504, to generate a first portion (e.g., a first cropped portion) 506 that is displayed during the nth display frame. Hereinafter, the term “a first portion” refers to a portion of the oversized image that is smaller than an entirety of the oversized image, unless specifically stated otherwise. The oversized image 502 may be a new image rendered by the system (e.g., rendered by the graphics card 314), or may be a recent image from a previous display frame (e.g., an n−1th display frame) stored in the buffer of the display device if the new image is not rendered and received in time for the nth display frame.

Referring to FIG. 5B, during an n+1th display frame, a new image is not received from the system (e.g., due to a long rendering time) in time to be displayed during the n+1th display frame, and thus, the oversized image 502 from the previous display frame (e.g., the nth display frame) is adjusted. The oversized image 502 is shifted according to new or updated sensor data SEN corresponding to an updated sensor reading, so that a different portion of the oversized image 502 from the nth display frame is displayed. Here, for example, the updated sensor data SEN corresponds to a head movement towards the right (e.g., in a yaw direction towards the right). Thus, the oversized image 502 is shifted towards the right (e.g., in a yaw direction towards the right) corresponding to the updated sensor data SEN by adjusting the start and end points of the pixel mapping of the oversized image 502, and a second portion (e.g., a second cropped portion) 506′ of the oversized image 502 is generated according to the updated sensor data SEN to be displayed during the n+1th display frame, so that the display device may maintain or substantially maintain 1:1 pixel mapping. Hereinafter, the term “a second portion” refers to a portion of the oversized image that is smaller than an entirety of the oversized image, unless specifically stated otherwise.

Accordingly, the display device according to some example embodiments of the present invention, may display an updated image according to the updated sensor readings (e.g., a recent or most recent sensor reading) during the corresponding display frame.

FIG. 5A and FIG. 5B depict a shifting operation on a single image. However, it is to be understood that this would also apply to dual views of a stereoscopic display. For example, an oversized image may be sent for both right and left views, and the display may crop from the right and left views, respectively, based on same SENS data. It shall be further understood that the oversized images for the right and left views may be stored either in a single buffer (e.g. side by side, top/bottom, even/odd rows/columns) or the oversized images may each be stored in separate buffers.

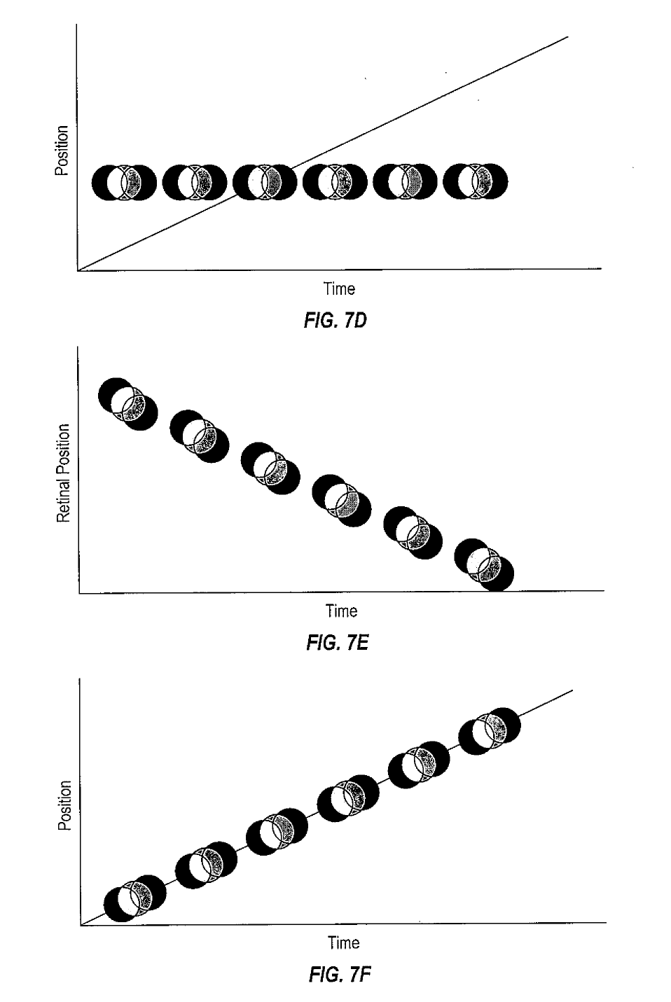

FIGS. 6A through 6C illustrate examples of aligning an overlay image over an object viewed through a transparent display device of a virtual or augmented reality display system according to tracked head movements from a perspective of the user. That is, as shown in FIGS. 6A through 6C, an object 602 is viewed through the transparent display device 600, and the overlay image 604 is displayed on the display device 600 as it would appear to the user. Thus, while the display device 600 may display the overlay image 604 and the object 602 (e.g., real light from the object 602 in an augmented reality system) as described above, FIGS. 6A through 6C show a composite image as a single image as it would appear from the perspective of the user.

FIG. 6A illustrates an example of the overlay image being displayed during a corresponding display frame when latency is introduced (e.g., during rendering), FIG. 6B illustrates an example of the overlay image being displayed during the corresponding display frame when latency is minimized or reduced according to some embodiments of the present invention, and FIG. 6C illustrates an example of combining (e.g., compositing) a secondary image (e.g., a frame-centric image) with the overlay image displayed during the corresponding display frame according to some embodiments of the present invention.

Referring to FIG. 6A, when latency is introduced (e.g., latency caused by rendering the overlay image), the overlay image 604 appears to trail the object 602 that is viewed through the display device 600 when the user makes a rapid head movement (e.g., pitch, yaw, roll). For example, some virtual or augmented reality display systems may render an updated overlay image according to an overlay position every other display frame, and thus, the overlay image 604 may appear to trail the object 602 as shown in FIG. 6A.

Referring to FIG. 6B, according to some example embodiments of the present invention, the overlay image 604 may be shifted (e.g., cropped) by the display device 600 to display a different portion of the overlay image 604 according to the detected head movements for each display frame. Thus, the overlay image 604 may be updated for each display frame according to the overlay position. For example, referring to FIG. 6B and FIGS. 5A through 5B, the display device 600 may receive an oversized overlay image. The display device 600 may shift (e.g., crop) the oversized overlay image by adjusting the start and end points of the pixel mapping of the oversized overlay image according to the sensor readings corresponding to the detected head movements. By shifting the oversized overlay image, the display device 600 may display different portions of the oversized overlay image during corresponding display frames.

When the display device receives a newly rendered oversized overlay image during an nth display frame (where n is an integer), the newly rendered oversized overlay image may be shifted to display a different portion of the overlay image. The oversized overlay image may be shifted according to a difference between the sensor data used for rendering the oversized overlay image (e.g., position metadata) and sensor data corresponding to a recent or most recent sensor reading. The oversized overlay image may then be cropped according to a screen size of the display device 600, to generate a first portion (e.g., a first cropped portion) of the oversized overlay image that is displayed during the nth display frame.

If the display device 600 does not receive another newly rendered oversized overlay image during an n+1th display frame (e.g., due to a long rendering time) to be displayed during the n+1th display frame, the display device 600 may resample the oversized overlay image from the previous display frame (e.g., the nth display frame), which may be stored in a buffer. The resampled oversized overlay image is shifted to display a different portion of the overlay image according to new or updated sensor data corresponding to an updated head position (e.g., updated overlay position). The shifted overlay image is cropped according to the screen size of the display device 600, and a second portion (e.g., a second cropped portion) of the overlay image is generated to be displayed during the n+1th display frame.

However, the present invention is not limited thereto, and in some embodiments, the display device may shift (e.g., crop) a regular sized overlay image (e.g., an overlay image corresponding to the screen size of the display device).

Referring to FIG. 6C, the shifting of the overlay image 604 is substantially the same as described above with reference to FIG. 6B, and thus, detailed description thereof will be omitted. In FIG. 6C, a fixed secondary image 606 (e.g., a frame-centric image) is additionally displayed on the display device 600. Here the fixed secondary image 606 refers to image content that remains in a fixed position with respect to the display screen, and thus, is unaffected by the head movements. In other words, the location of the fixed secondary image 606 with respect to the display screen does not change with respect to the detected head movements.

According to some embodiments of the present invention, the display device 600 may further receive a secondary image signal corresponding to the fixed secondary image 606 and alpha mask data (e.g., a fourth color channel indicating how to combine, or blend, or composite the images). The alpha mask data may include data to determine the translucent or opaque characteristics of the fixed secondary image 606. The display buffer may further include a secondary buffer to store the fixed secondary image 606. The display device may combine (e.g., blend or composite) the overlay image that has been shifted according to the detected head movements with the fixed secondary image 606 according to the alpha mask data. Thus, the display device may display an updated overlay image according to the head movements, while also displaying the fixed secondary image 606 at a fixed position on the display screen.

FIG. 6A through FIG. 6C depict a shifting operation on a single overlay image 604. However, it is to be understood that this would also apply to dual views of a stereoscopic display. For example, an overlay image may be sent for both right and left views, and the display may crop from the right and left views, respectively, based on same SENS data. It shall be further understood that the overlay images for the right and left views may be stored either in a single buffer (e.g. side by side, top/bottom, even/odd rows/columns) or the overlay images may each be stored in separate buffers.

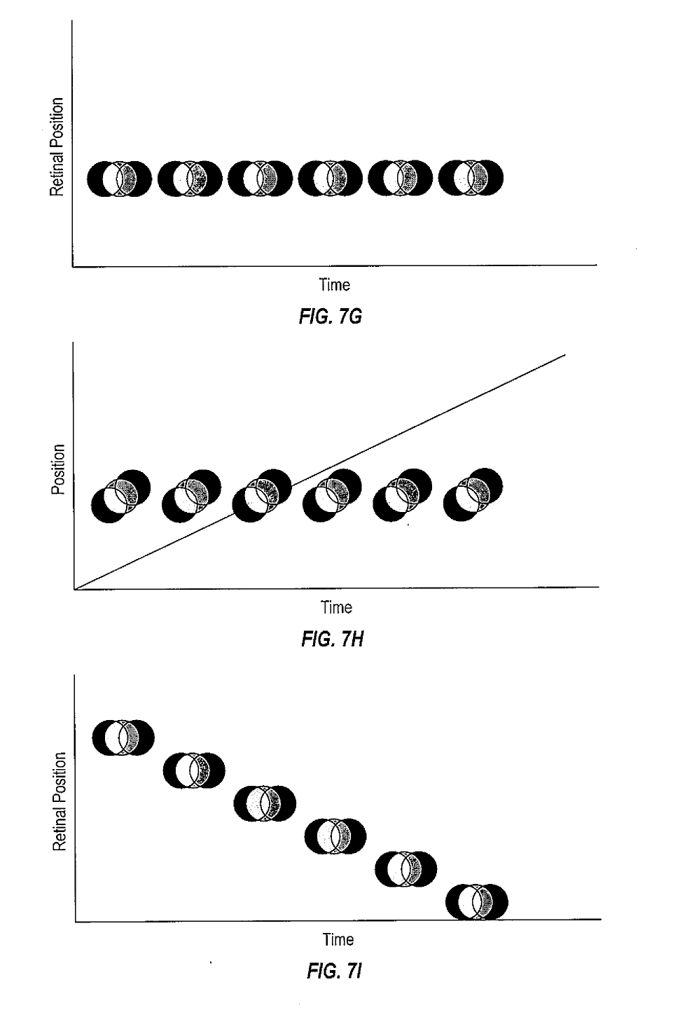

FIGS. 7A through 7E illustrate examples of color breakup in a color sequential display, and FIGS. 7F through 7I illustrate examples of compensating for color subframes according to detected head movements.

Referring to FIG. 7A through 7E, some light-weight HMDs display color sequentially. When viewing a display, a user will typically attempt (either consciously or reflexively) to stabilize an object on their retina. With color sequential displays, this stabilizing effort may cause an object to fringe or have the colors “break up,” so that white parts of images being displayed appear to have red, green, and blue fringes. As shown in FIG. 7A, as the user is making a large head movement from, for example, the left to the right (e.g., in a yaw direction towards the right), the image of the white flower appears to show the red, green, and blue fringes.

In more detail, as shown in FIGS. 7B through 7C, when there is a head movement while tracking a moving object, and the eye attempts to stabilize the moving object on the retina, there is a clear banding of the colors in the retinal signal. For example, as shown in FIG. 7B, the head movement, which is represented by the straight line, is following the object, which is represented by red, green, and blue color channels. In this example, the head movement may keep up with one of the color channels, in this case red, but another one of the color channels is lagging behind, in this case blue. Thus, as shown in FIG. 7C, the red, green, and blue color channels do not coincide, and the image appears on the retina as having color fringes.

As shown in FIGS. 7D through 7E, when there is a head movement across a static object, and the eye does not try to fixate on the static object during the head movement, there may still be significant color break up where there would normally be motion blur of the static object.

However, referring to FIGS. 7F through 7I, according to some embodiments of the present invention, the color channels may be corrected as shown in FIG. 7F, and the image presentation delay may be compensated for the head movement, which may reduce the banding in the retinal images. For example, as shown in FIG. 7F, the color channels are shifted according to the direction of the head movements, so that as shown in FIG. 7G, the color channels coincide on the retina. As shown in FIGS. 7H and 7I, the correction may be applied to untracked imagery as well without exacerbating color banding.

Thus, according to some embodiments of the present invention, the display device may receive the sensor data corresponding to the detected head movements and may compensate for color subframes (e.g., color channels) by shifting corresponding color subframes according to the detected head movements. In other words, the display device may display corresponding portions of different color subframes when the sensor data indicates that different portions of the color subframes are to be displayed. Accordingly, the color “break up” effect may be reduced or mitigated.

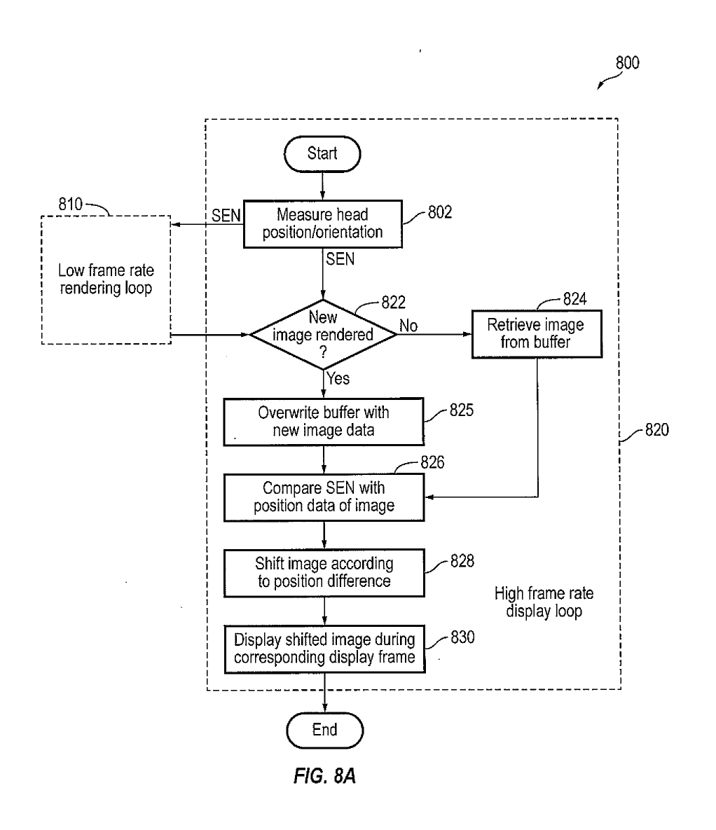

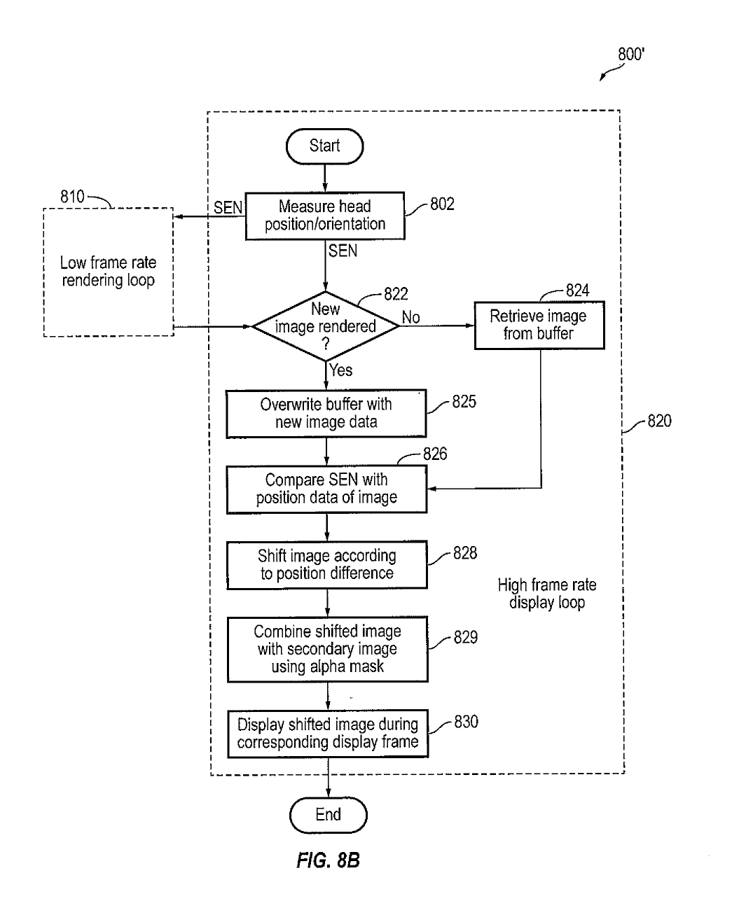

FIG. 8A illustrates an accelerated head tracking method according to some embodiments of the present invention. However, the present invention is not limited to the sequence or number of the operations of the method shown in FIG. 8A, and can be altered into any desired sequence or number of operations as recognized by a person of ordinary skill in the art. For example, in some embodiments, the order may vary, or the method may include fewer or additional operations.

Referring to FIG. 8A, the accelerated head tracking method may include a low frame rate rendering loop 810, which may be volatile or unstable, and a high frame rate display loop 820, which may be substantially stable. The high frame rate display loop 820 may have a refresh frame rate that is greater than or equal to that of the low frame rate rendering loop 810.

Referring to FIG. 8A, the high frame rate display loop 820 may include operations to display a shifted image according to the detected head movements.

In operation 802, head position/orientation may be measured by a sensor (e.g., gyroscopes, accelerometers, magnetometers, etc.), and sensor data SEN corresponding to the head position/orientation may be generated and transmitted to both the low frame rate rendering loop 810 and the high frame rate display loop 820. The sensor data SEN corresponding to the head position/orientation may include, for example, a time stamp and position frame data.

In some example embodiments, the low frame rate rendering loop may include operations to render a new image (e.g., operations by the main processor and the graphics card, collecting user inputs, etc.), and thus, description thereof will be omitted.

In the high frame rate display loop, the display device determines if a new image has been rendered by the low frame rate rendering loop at operation 822. If a new image has not been rendered by the low frame rate rendering loop at operation 822, the display device retrieves a latest image at operation 824, which may be stored in a buffer of the display device. The latest image may correspond to an oversized image or an oversized overlay image from a previous rendered frame (e.g., an n−1th frame, where n is the current frame) as described above, but the present invention is not limited to the oversized image or the oversized overlay image. If a new image has been rendered and received from the low frame rate rendering loop at operation 822, the buffer of the display device is overwritten with new image data at operation 825.

In operation 826, the sensor data SEN corresponding to the most recent head position/orientation reading is compared with position data of the most recent image data to determine a position difference. For example, a timestamp and position frame data of the new or latest image may be compared with the sensor data to determine the position difference.

In operation 828, the new or latest image is shifted (and/or cropped) according to the position difference, if any, and the shifted image is displayed during a corresponding display frame at operation 830.

Following operation 828, the display may optionally introduce geometric correction to correct for optical distortions that may be present with a near eye display system.

Accordingly, the image displayed during the corresponding display frame may correspond to a more recent head position/orientation measurement than the new image rendered by the low frame rate rendering loop 810.

FIG. 8B illustrates an accelerated head tracking method according to some embodiments of the present invention. The accelerated head tracking method of FIG. 8B is substantially the same as that of FIG. 8A, and thus, detailed description of the substantially same portions will be omitted. However, the present invention is not limited to the sequence or number of the operations of the method shown in FIG. 8B, and can be altered into any desired sequence or number of operations as recognized by a person of ordinary skill in the art. For example, in some embodiments, the order may vary, or the method may include fewer or additional operations.

Referring to FIG. 8B, the image to be displayed during the corresponding display frame further includes a fixed secondary image (e.g., a frame-centric image) as described above with reference to FIG. 6C. Thus, in the high frame rate display loop 820, an operation 829 is further included.

In operation 829, the shifted image from operation 828 is combined (e.g., composited) with the fixed secondary image using the alpha mask data. The fixed secondary image may include, for example, menu graphics, live video feed, information corresponding to the overlay image, etc.

Following operation 828, the display may optionally introduce geometric correction to correct for optical distortions that may be present with a near eye display system.

In operation 830, the combined shifted and fixed secondary image is displayed during the corresponding display frame. The shifted image corresponds to the detected head movements, and a position of the fixed secondary image is fixed within the display screen.

Accordingly, the display device according to some embodiments of the present invention may be closely integrated with a sensor to shift an image according to updated sensor readings corresponding to updated head movements at a time closer to a time for displaying the image during a corresponding display frame.

In some embodiments, the image may include an oversized image, and the oversized image may be shifted according to the detected head movements.

In some embodiments, the image may include an overlay image or an oversized overlay image, and the overlay or oversized overlay image may be shifted according to the detected head movements.

In some embodiments, the display device may display color sequentially, and color subframes of the image may be shifted according to the detected head movements.

In some embodiments, the display device may receive a secondary image (e.g., a frame-centric image), and the display device may combine the shifted image with the secondary image to be displayed during the corresponding display frame.

Although the present invention has been described with reference to the example embodiments, those skilled in the art will recognize that various changes and modifications to the described embodiments may be performed, all without departing from the spirit and scope of the present invention. Furthermore, those skilled in the various arts will recognize that the present invention described herein will suggest solutions to other tasks and adaptations for other applications. It is the applicant's intention to cover by the claims herein, all such uses of the present invention, and those changes and modifications which could be made to the example embodiments of the present invention herein chosen for the purpose of disclosure, all without departing from the spirit and scope of the present invention. Thus, the example embodiments of the present invention should be considered in all respects as illustrative and not restrictive, with the spirit and scope of the present invention being indicated by the appended claims and their equivalents.

What is claimed is:

1. A display system comprising:
a sensor configured to detect head movements and to generate sensor data corresponding to the head movements; and
a display device configured to display a first portion of an image according to the sensor data, the first portion being smaller than an entirety of the image.

2. The system of claim 1, wherein the image comprises an oversized image.

3. The system of claim 2, wherein the display device is further configured to crop the oversized image to generate the first portion of the oversized image corresponding to the sensor data during a display frame, and to crop the oversized image to display a second portion of the oversized image corresponding to updated sensor data during a next display frame.

4. The system of claim 2, wherein the display device is further configured to resample the oversized image to generate the first portion of the oversized image corresponding to the sensor data during a display frame.

5. The system of claim 1, wherein the image comprises an overlay image.

6. The system of claim 5, wherein the display device is further configured to crop the overlay image to generate the first portion of the overlay image corresponding to the sensor data during a display frame, and to crop the overlay image to display a second portion of the overlay image corresponding to updated sensor data during a next display frame.

7. The system of claim 6, wherein the display device is further configured to combine the cropped overlay image with a fixed secondary image.

8. The system of claim 1, wherein the display device is further configured to display color sequentially, and to display corresponding portions of different color subframes when the sensor data indicates different portions of color subframes are to be displayed.

9. A display device comprising:
a buffer configured to store an image; and
a controller configured to generate image data to be displayed corresponding to a first portion of the image according to sensor data corresponding to head movements, the first portion being smaller than an entirety of the image.

10. The display device of claim 9, wherein the image comprises an oversized image.

11. The display device of claim 10, wherein the controller is further configured to crop the oversized image to generate the image data corresponding to the first portion of the oversized image corresponding to the sensor data during a display frame, and to crop the oversized image to generate the image data corresponding to a second portion of the oversized image corresponding to updated sensor data during a next display frame.

12. The display device of claim 9, wherein the image comprises an overlay image.

13. The display device of claim 12, wherein the controller is further configured to crop the overlay image to generate the image data corresponding to the first portion of the overlay image corresponding to the sensor data during a display frame, and to crop the overlay image to generate the image data corresponding to a second portion of the overlay image corresponding to updated sensor data during a next display frame.

14. The display device of claim 13, wherein the buffer comprises a secondary buffer configured to store a fixed secondary image, and the controller is further configured to combine the cropped overlay image with the fixed secondary image.

15. The display device of claim 9, wherein the display device is configured to display color sequentially, and the controller is further configured to generate the image data with corresponding portions of different color subframes when the sensor data indicates different portions of color subframes are to be displayed.

16. An accelerated head tracking method comprising:
receiving, by a display device, sensor data corresponding to head movements; and
displaying, by the display device, a portion of an image according to the sensor data, the portion being smaller than an entirety of the image.

17. The method of claim 16 further comprising:
comparing, by the display device, position metadata corresponding to the image with the sensor data to determine a position difference,
wherein the portion of the image corresponds to the position difference.

18. The method of claim 16, wherein the image comprises an oversized image.

19. The method of claim 18, wherein the oversized image corresponds to an oversized overlay image.

20. The method of claim 16, wherein the image corresponds to an image of a previous frame that is stored in a buffer, and the method further comprises:
resampling, by the display device, the image stored in the buffer; and
comparing, by the display device, position metadata corresponding to the image with the sensor data to determine a position difference,
wherein the portion of the image corresponds to the position difference.

21. The method of claim 16 further comprising:
receiving, by the display device, a fixed secondary image; and
combining, by the display device, the portion of the image with the fixed secondary image.
